(19) United States
(12) Patent Application Publication
(10) Pub. No.: US 2026/0217235 A1
(43) Pub. Date: Jul. 30, 2026

(54) SENSOR DEVICE FOR A BRAKE SYSTEM, ACTUATOR DEVICE FOR A BRAKE SYSTEM, AND A BRAKE SYSTEM FOR A MOTOR VEHICLE

(71) Applicant: HELLA GMBH & CO. KGAA, Lippstadt (DE)

(72) Inventors: Julien Bungalski, Kirchlinteln (DE); Carsten Kügeler, Lippstadt (DE); Marcel Morfeld, Lippetal (DE)

(21) Appl. No.: 19/457,380

(22) Filed: Jan. 23, 2026

(30) Foreign Application Priority Data
Jan. 24, 2025 (DE) 102025102592.4

(51) Int. Cl. B60T 17/22; B60T 7/04

(52) U.S. Cl. CPC B60T 17/22; B60T 7/042; B60T 2220/04

(57) ABSTRACT

A sensor device for a brake system of a motor vehicle is provided. The sensor device includes a vibration sensor configured to be attached to a brake component of a brake system. The vibration sensor is configured to detect structural vibrations in the brake component. The sensor device further includes an evaluation unit which is communicatively coupled to the vibration sensor. The evaluation unit is configured to estimate, from sensor signals from the vibration sensor, a clamping force between a body-side brake component and a vehicle-wheel-side brake component of the brake system which interacts with the body-side brake component during the braking process.

### CROSS-REFERENCE TO RELATED APPLICATIONS

This application claims the benefit of German Patent Application 10-2025-102-592.4, filed Jan. 24, 2025, the disclosure of which is incorporated by reference in its entirety.

### FIELD OF THE INVENTION

The invention relates to a sensor device for a brake system, an actuator device for a brake system, and a brake system for a motor vehicle.

### BACKGROUND OF THE INVENTION

A brake system usually comprises a braking device and an actuation unit that operates the braking device. The braking device can be a drum brake device or a disc brake device. The drum brake device usually comprises a drum brake and movably mounted brake linings, wherein the brake linings can be pressed against the drum brake by the actuation unit in order to cause a friction-induced braking process. The disc brake device usually comprises a brake disc and movably mounted brake pads, whereby the brake pads can be pressed against the brake disc by the actuation unit in order to cause a friction-induced braking process. The actuation unit can be of conventional design, with a mechanical coupling to a brake pedal that can be actuated by a driver such that each actuation of the brake pedal is transmitted directly mechanically to the brake linings and the brake linings are pressed against the drum brake or brake disc. Alternatively, the actuation unit is designed as an actuator device and forms part of a so-called brake-by-wire brake system. There is no mechanical connection between the brake pedal and the braking device, wherein actuation of the brake pedal is detected by a sensor and an electric motor of the actuator device is controlled based on the sensor signal and other required parameters. A parameter required to control the electric motor, i.e., the clamping force, is usually provided by a force sensor, whereby the clamping force between the brake linings and the drum brake or brake disc, i.e., between a body-side brake component and a vehicle-wheel-side brake component of the braking device, is determined from the sensor signals of the force sensor. By determining and taking into account the clamping force when controlling the electric motor of the actuator device, a desired clamping force can be adjusted and thus a braking effect desired by the driver can be reliably provided.

The disadvantage of such a force sensor is that the force sensor is expensive, as it is particularly costly to manufacture. The force sensor must necessarily be arranged in the force transmission path, i.e., within the braking device or within the brake system, whereby the installation space within the brake system is very limited and therefore complicates the design of the brake system.

### SUMMARY OF THE INVENTION

The task of the invention is therefore to provide a sensor device for a brake system which can be designed simply and inexpensively. In addition, the design of the brake system containing the sensor device is to be simplified.

The sensor device comprises a vibration sensor which is designed to be attached to a brake component of a brake system or is attached to the brake component in such a way that the vibrations, i.e., the structure-borne vibrations of the brake component, are detected. The sensor signal of the vibration sensor thus indicates the structure-borne vibrations of the brake component in all driving states of the vehicle or in all operating states of the brake system. The vibration sensor is preferably designed as a load cell. In particular, the vibration sensor is a piezoelectric sensor. Alternatively, the vibration sensor can be designed as an acceleration sensor.

The sensor device also includes an evaluation unit which is operatively connected via signal to the vibration sensor. The evaluation unit is used to evaluate the sensor signals from the vibration sensor. In particular, the evaluation unit is used to determine a clamping force between at least one body-side brake component and a vehicle-wheel-side brake component of the brake system.

When determining the clamping force from the sensor signals of the vibration sensor, the changing vibration behavior of the brake component is used as a function of the tension or load on the brake components. This allows the structure-borne vibrations caused by the tensioning of the brake components to be determined with specific vibration amplitudes and vibration frequencies, and for the clamping force to be inferred on this basis. In particular, there is a change in the frequency spectrum or a frequency shift, in particular a shift in the resonant frequency, depending on the tensioning of the brake component. The clamping force can be estimated on the basis of the determined change in the frequency spectrum caused by a certain tension or load.

This allows the clamping force between the two brake components and thus the braking force to be determined indirectly by detecting the structure-borne vibrations of the brake component carrying the vibration sensor, whereby the vibration sensor is not arranged in the force path of the brake system. In particular, the vibration sensor can be arranged at almost any point on the brake component, as the structure-borne vibrations are present to a greater or lesser extent at any point on the brake component.

Preferably, the evaluation unit is designed to estimate a change in the clamping force of the braking device from a change in the sensor signal of the vibration sensor. In particular, the evaluation unit is designed to use the determined clamping force or the change in clamping force to determine a time at which the body-side brake component comes into contact with a vehicle-wheel-side brake component. In other words, the contact of the body-side brake component with the vehicle wheel-side brake component can be detected by the fact that a predefined change in the frequency spectrum takes place in the sensor signals of the vibration sensor, whereby this change in the frequency spectrum indicates the point in time at which the clamping force is 0 N. The clamping force then increases. An actuator device of the brake system can be controlled continuously based on the sensor signals of the vibration sensor, whereby the instantaneous clamping force is continuously estimated from the sensor signals of the vibration sensor. Alternatively, the drive unit can be controlled as a function of the sensor signal of the vibration sensor in a first time period, which lasts until the brake components are in contact with each other, i.e., until the predefined contact vibration characteristic is present and the 0-Newton point is defined, and then controlled based on other parameters, for example based on the motor parameters of the actuator device. Because the contact between the brake components is determined using the sensor signals from the vibration sensor, the drive device can be controlled independently of the wear on the brake components. On the other hand, the sensor signal from the vibration sensor can be used to estimate the wear of the brake components and detect a defect in the brake system.

In a preferred embodiment, the evaluation unit is designed in such a way that the structure-borne vibrations of the brake component are actively determined based on the sensor signals of the vibration sensor in such a way that the vibration sensor and/or the brake component are excited in a predefined manner. The vibration sensor and/or the brake component accommodating the vibration sensor receive a vibration excitation, for example by an actuator, in such a way that a predefined structure-borne vibration of the vibration sensor or the brake component is present. Based on the initial structure-borne vibration caused by the vibration excitation, the change in vibration is determined and the clamping force or change in clamping force is calculated on this basis. This means that structure-borne vibrations of the vibration sensor and/or the brake component, which are present when the vehicle is in motion and are irrelevant for determining the clamping force and may even distort it, can be suppressed. Alternatively, the evaluation unit is designed in such a way that the structure-borne vibrations of the brake component are determined passively based on the sensor signals of the vibration sensor, i.e., without a predefined vibration excitation of the brake component accommodating the vibration sensor and/or of the vibration sensor.

The task is also solved by an actuator device for a brake system, which has a drive unit which is designed to actuate a braking device, and a sensor device according to the embodiments disclosed herein. In particular, the drive unit is an electromechanical drive unit. Preferably, the electromechanical drive unit comprises an electric motor and a gear mechanism, whereby the gear mechanism converts a rotational movement of the electric motor into a translational movement. The translational movement is used to shift one of the brake components. The gear mechanism is a screw drive mechanism, for example.

The task is further solved by a brake system for a motor vehicle, which has a braking device and an actuator device according to further embodiments of the invention. In addition, the brake system comprises a pedal device which has a movable pedal element, i.e., a pedal element which is pivotable or displaceable in a translational manner, and a pedal sensor for determining a pedal travel of the pedal element when the pedal element is actuated and/or a pedal force applied to the pedal element when the pedal element is actuated. In addition, the pedal device can have a pedal return unit which causes a pedal return when the pedal element is actuated, thereby creating an actuation sensation for the driver.

When the brake system is actuated, the pedal sensor detects the actuation of the pedal element. The drive unit is controlled based on the sensor signal from the pedal sensor, the sensor signal from the vibration sensor and, if necessary, taking other parameters into account. When the drive unit is actuated, one of the brake components is displaced in the direction of the other brake component, whereby as soon as an existing gap between the two brake components has been overcome, the brake components bear against one another and a clamping force is built up.

The braking device is preferably a drum brake device or a disc brake device. A drum brake device comprises a drum brake and displaceable brake linings, the brake linings being operatively connected to the drive unit in such a way that the brake linings, which are biased into a non-contact position, are displaced in the direction of a friction surface of the drum brake when the drive unit is actuated and are pressed more or less against the friction surface depending on the actuation of the drive unit. In particular, the vibration sensor is arranged or attached to the drum brake. The disc brake device comprises a brake disc and displaceable brake pads, whereby the brake pads are operatively connected to the drive unit. As with the drum brake device, the brake linings are displaced when the drive unit is actuated and pressed against a friction surface of the brake disc. The brake pads are mounted on a brake caliper. The vibration sensor is arranged or attached to the brake caliper.

Preferably, the vibration sensor is arranged outside the direct force flow, in particular on an outer side of the body-side brake component, i.e., the brake caliper or the drum brake, facing the external environment. This allows the vibration sensor to be easily arranged or attached to the braking device. In particular, the vibration sensor can be arranged outside the force path of the brake system, whereby the clamping force is determined indirectly based on the sensor signal of the vibration sensor. Alternatively, the vibration sensor can also be arranged within the force path.

### BRIEF DESCRIPTION OF THE DRAWINGS

The invention is explained in more detail hereafter with reference to the accompanying drawings. In the drawings:

FIG. 1 is a first version of a brake system in schematic view;

FIG. 2 is a second version of a brake system in schematic view; and

FIG. 3 is a frequency spectrum of a sensor signal of a vibration sensor of a sensor device of the brake system from FIG. 1 or from FIG. 2.

DETAILED DESCRIPTION OF THE CURRENT EMBODIMENTS

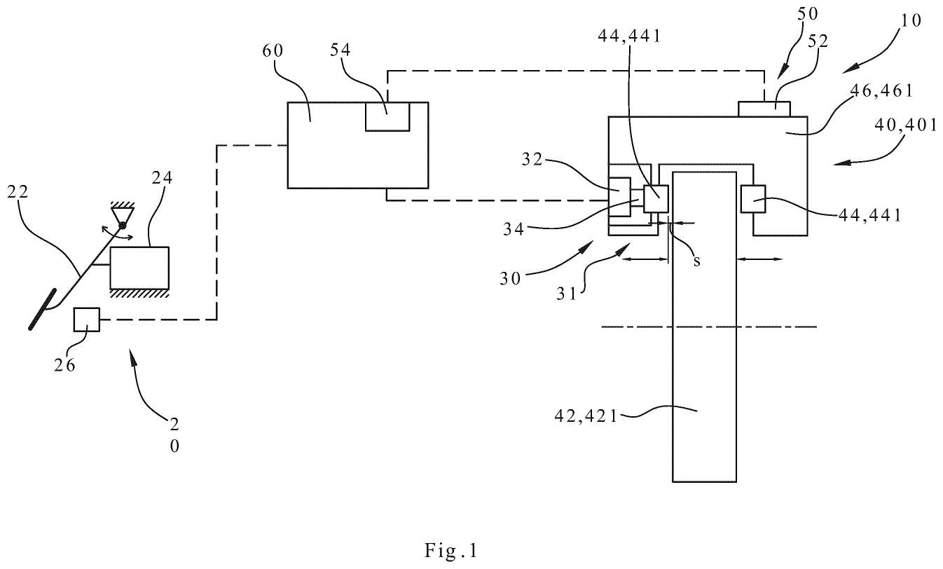

FIG. 1 is a brake system 10 of a vehicle. The brake system 10 is designed as a brake-by-wire brake system and comprises a pedal device 20, an actuator device 30, a braking device 40 and a sensor device 50. Such a brake-by-wire brake system is characterized in particular by the fact that there is no mechanical connection between the pedal device 20 and the braking device 40, whereby an actuation of the braking device is detected and, based on this, the braking device 40 is actuated by the actuator device 30.

The pedal device 20 comprises a brake pedal 22, which is arranged in a vehicle interior and is pivotably mounted on a support structure of the vehicle. Alternatively, the brake pedal 22 can also be mounted on the support structure so that it can be displaced in a translational manner. The brake pedal 22 is connected to a return unit 24, which is attached to the support structure and is designed to produce a counterforce or a return force when the brake pedal 22 is loaded and displaced by a person. Usually, the return unit 24 has at least one spring element which causes the return force or the counterforce, whereby the spring characteristic is selected in such a way that the driver is given a braking sensation.

The pedal device 20 further comprises a brake pedal sensor 26, which is operatively connected via signal to a control unit 60. The brake pedal sensor 26 detects the pedal travel of the brake pedal 22, which is traveled when the brake pedal 22 is actuated or loaded by the driver or a person.

The actuator device 30 is designed as an electric motor drive device and therefore comprises a drive unit 31 with an electric motor 32 and a motion conversion unit 34. The electric motor 32 has a stator and a rotor, whereby the stator being electrically connected to the control unit 60 and the rotor being non-rotatably connected to the motion conversion unit 34. The motion conversion unit 34 is designed as a screw drive, for example, and is used to convert a rotational movement of the rotor into a translational movement. For example, a threaded nut is driven, i.e., rotated, by the rotor, whereby a threaded lead screw interacts with the threaded nut and is mounted for translational movement performs a translational movement in response to rotation movement of the threaded nut.

The braking device 40 is designed as a disc brake device 401 and comprises a vehicle-wheel-side brake component 42, in the present case, a brake disc 421, two body-side brake components 44, in the present case, two brake pads 441, and a further brake component 46 serving as a support for the braking device 40, in the present case a brake caliper 461. The brake caliper 461 is attached to the support structure of the vehicle. The brake pads 441 are mounted on the brake caliper 461 so that they can be displaced in a translational manner. In addition, the brake pads 441 are operatively connected to the actuator device 30, i.e., to the motion conversion unit 34 at an output side thereof, such that, upon actuation of the electric motor 32, the brake pads 441 can be selectively displaced in a translational manner. In the non-actuated state of the electric motor 32, i.e., while no actuation of the electric motor 32 is present, the brake pads 441 are spaced apart from the brake disc 421 due to a spring pretension caused by a spring element, such that there is a gap s between the brake pads 441 and the brake disc 421, i.e., between the friction surfaces of the brake pads 441 and the brake disc 421. The vehicle-wheel-side brake unit 42, i.e., the brake disc 421, is non-rotatably connected to a wheel hub or to a wheel carrier.

The sensor device 50 comprises a vibration sensor 52, which is attached to the brake caliper 461 and is designed to detect the structure-borne vibrations of the brake caliper 461. The sensor device 50 also comprises an evaluation unit 54, which serves to process the sensor signal of the vibration sensor 52, if necessary, and in particular to evaluate it in such a way that the sensor signal can be used to operate the brake system 10. In the present case, the evaluation unit 54 is a component of the control unit 54, whereby the evaluation unit 54 can also be designed independently and/or can be integrated into the vibration sensor 52.

When the vehicle is being driven, an actuation of the brake pedal 22 by the driver, i.e., at the driver's request, is detected by the brake pedal sensor 26, whereby the sensor signal of the brake pedal sensor 26 is transmitted to the control unit 60. Depending on the sensor signal from the brake pedal sensor 26, among other things, the electric motor 32 is actuated, whereby the brake pads 441 are displaced in the direction of the brake disc 421 and loaded. As soon as the brake pads 441 are in contact with the brake disc 421, a frictional effect is caused between the brake pads 441 and the brake disc 421 and thus a braking effect, whereby the braking effect depends on the load caused by the electric motor 32 and transmitted to the brake pads 441 by the motion conversion unit 34.

The electric motor 32 is also controlled as a function of motor parameters, i.e., by the current strength and the electrical voltage, as well as by the sensor signal from the vibration sensor 52, whereby the current clamping force between the brake pads 441 and the brake disc 421, which is relevant for controlling the electric motor 32, is determined from the sensor signal from the vibration sensor 52 by the evaluation unit 54. For this, the changing vibration behavior of the brake component 46, i.e., the brake caliper 461, is used as a function of the tensioning or loading of the brake caliper 461 due to the clamping of the brake disc 421 between the brake pads 441 and the support of the brake pads 441 on the brake caliper 461, whereby the structure-borne vibrations caused by the tensioning are determined with specific vibration amplitudes and vibration frequencies and the clamping force is inferred based on this. In particular, there is a change in the frequency spectrum and a frequency shift, in particular a shift in the resonant frequency, depending on the tensioning of the brake component 46. The clamping force can be estimated on the basis of the determined frequency spectrum change caused by certain tensions or loads.

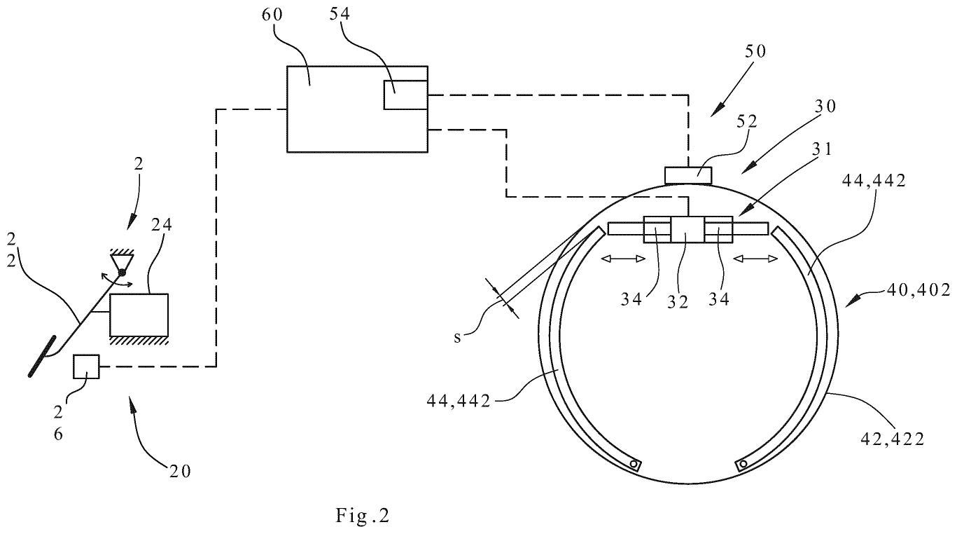

FIG. 2 is a second version of the brake system 10. The decisive difference of the first embodiment in FIG. 1 is that the braking device 40 is designed as a drum brake device 402 instead of a brake disc device 401. The drum brake device 402 comprises two body-side brake components 44, in the present case two pivotably mounted brake linings 442, and a vehicle-wheel-side brake component 42, in the present case a drum brake 422. The actuator device 30 is operatively connected to the brake linings 442. The vibration sensor 52 is attached to the drum brake 442 and thus detects the structure-borne vibrations of the drum brake 442. The mode of operation of the brake system 10 corresponds to the mode of operation of the first version of the brake system 10 shown in FIG. 1.

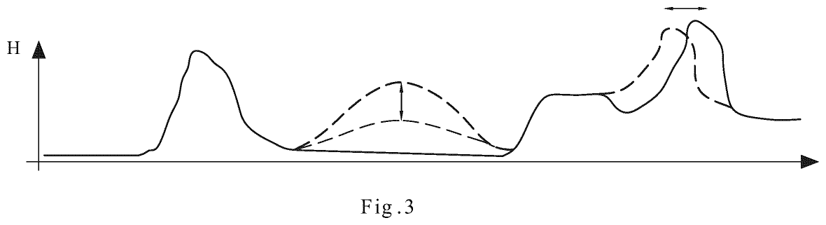

FIG. 3 is an example of a frequency spectrum of the sensor signal of the vibration sensor 52 according to the designs of the brake systems 10 in FIG. 1 and in FIG. 2. The solid line shows the frequency spectrum when the brake device 40 is not actuated, i.e., when there is no braking operation. The dashed line shows a frequency spectrum during a braking process. According to FIG. 3, the vibration sensor 52 and/or the brake component 42, 46 carrying the vibration sensor 52 receives a vibration excitation in such a way that a predefined structure-borne vibration of the vibration sensor 52 and/or the brake component 42, 46 is present. Starting from the output structure-borne vibration caused by the vibration excitation, the change in the vibrations is determined and, based on this, the clamping force required for controlling the electric motor 32 is determined. Alternatively, the clamping force can also be determined without a vibration excitation of the vibration sensor 52 and/or the brake component 42, 46, i.e., passively, wherein in this case as well a change in the frequency spectrum can be determined and the clamping force can be estimated on this basis.

### List of reference symbols

10 brake system

20 pedal device

22 brake pedal

24 return unit

26 brake pedal sensor

30 actuator device

31 drive unit

32 electric motor

34 motion conversion unit

40 braking device

401 disc brake device

402 drum brake device

42 vehicle-wheel-side brake component

421 brake disc

422 brake caliper

44 body-side brake component

441 brake pad

46 additional brake component

461 brake caliper

50 sensor device

52 vibration sensor

54 evaluation unit

60 control unit

The above description is that of a current embodiment of the invention. Various alterations and changes can be made without departing from the spirit and broader aspects of the invention. This disclosure is presented for illustrative purposes and should not be interpreted as an exhaustive description of all embodiments of the invention or to limit the scope of the claims to the specific elements illustrated or described in connection with these embodiments. Any reference to elements in the singular, for example, using the articles “a,” “an,” “the,” or “said,” is not to be construed as limiting the element to the singular.

1. A sensor device for a brake system of a motor vehicle, comprising:
a vibration sensor which is configured to be attached to a brake component of a brake system and to detect structure-borne vibrations of the brake component; and
an evaluation unit which is communicatively coupled to the vibration sensor and is designed to estimate, from sensor signals of the vibration sensor, a clamping force between at least one body-side brake component and a vehicle-wheel-side brake component of the brake system which interacts with the body-side brake component during the braking process.

2. The sensor device of claim 1, wherein the evaluation unit is designed to determine a time of contact of the body-side brake component with a vehicle-wheel-side brake component from the clamping force determined.

3. The sensor device of claim 1, wherein the evaluation unit is configured such that an active determination of the structure-borne vibrations of the brake component based on the sensor signals of the vibration sensor takes place in such a way that the vibration sensor or the brake component receiving the vibration sensor are excited in a predefined manner.

4. The sensor device of claim 1, wherein the evaluation unit is configured such that a passive determination of the structure-borne vibrations of the brake component is carried out based on the sensor signals of the vibration sensor.

5. An actuator device for a brake system, comprising:
a drive unit configured to actuator a braking device;
the sensor device of claim 1; and
a control unit which is communicatively coupled to the drive unit and to the sensor unit.

6. A brake system for a motor vehicle, comprising:
a braking device; and
the actuator device of claim 5.

7. The brake system of claim 6, further comprising a pedal device, the pedal device including a brake pedal sensor configured to detect pedal travel or configured to detect an actuating force applied to the pedal device, the brake pedal sensor being communicatively coupled to the control unit of the actuator device.

8. The brake system of claim 6, wherein the braking device is a drum brake device or a disc brake device.

9. The brake system of claim 6, wherein the vibration sensor is disposed on an outer side of the brake component.

10. The brake system of claim 9, wherein the vibration sensor is disposed on the outer side of the brake component facing an external environment.
